(19) United States
(12) Patent Application Publication
(10) Pub. No.: US 2025/0136339 A1
(43) Pub. Date: May 1, 2025

(54) NOTCH LOCK LOOP AND METHODS OF USE

(71) Applicant: Wayne Evan Quarles, Cleveland, GA (US)

(72) Inventor: Wayne Evan Quarles, Cleveland, GA (US)

(21) Appl. No.: 18/927,463

(22) Filed: Oct. 25, 2024

Related U.S. Application Data
(60) Provisional application No. 63/546,137, filed on Oct. 27, 2023.

(51) Int. Cl. B65D 63/12

(52) U.S. Cl. CPC B65D 63/12; B65D 2563/108

(57) ABSTRACT

A notch lock loop and methods of use to provide an apparatus to secure the collectable therein, having a collection apparatus to gather and hold one or more collectables having a wire configured as a loop with a first wire end and a second wire end, the first wire end being bent inward approximately ninety degrees tangent the loop and second wire end being bent inward approximately ninety degrees tangent the loop, the first wire end configured to overlap the second wire end to form a notch and thus, configured to collect and hold wire, cable, twine, rope, or the like.

### CROSS-REFERENCE TO RELATED APPLICATIONS

To the full extent permitted by law, the present United States Non-provisional Patent Application hereby claims priority to and the full benefit of United States Provisional Application entitled “V-NOTCH LOCK LOOP COLLECTION APPARATUS AND METHODS OF USE,” having assigned serial number 63/546,137, filed on Oct. 27, 2023, incorporated herein by reference in its entirety.

### FIELD OF THE DISCLOSURE

The present disclosure is directed to a collection apparatus. More specifically, the present disclosure is directed to an apparatus to hold part(s) together and affix to a surface.

### BACKGROUND

A variety of collection apparatus have been used such as zip ties or twist it for wires or cables, rubber bands and string to bundle all sorts of things, nails or screws to attach multiple boards for example. Split key rings, binder rings, and line rings are used to bundle keys and other items.

A disadvantage with conventional collection apparatus is that they are difficult to load with the collectable.

Another disadvantage with conventional collection apparatus is that are not affixed with an attachment mechanism to adhere the collection apparatus to a surface for example.

Therefore, it is readily apparent that there is a recognizable unmet need for a notch lock loop and methods of use that may be configured to address at least some aspects of the problems discussed above.

### SUMMARY

Briefly described, in an example embodiment, the present disclosure may overcome the above-mentioned disadvantages and may meet the recognized need for a notch lock loop and methods of use to provide an apparatus to secure the collectable therein, the preferred apparatus having a collection apparatus to gather and hold one or more items having a wire configured as a loop with a first wire end and a second wire end, the first wire end being bent inward approximately ninety degrees tangent and second wire end being bent inward approximately ninety degrees tangent the loop, the first wire end configured to overlap the second wire end to form a notch and thus, configured to collect and hold wire, cable, twine, rope, or the like.

Accordingly, in one aspect, the present disclosure may enable collection and holding of the collectable by inserting therethrough the notch.

Accordingly, in another aspect, the present disclosure may configured to collect and hold wire, cable, twine, rope, or the like therein notch lock loop.

In an exemplary embodiment of a collection apparatus to gather and hold one or more collectables, including an elongated element configured as a loop, the elongated element having a first elongated element end and a second elongated element end, the first elongated element end being bent inward approximately ninety degrees tangent to the loop and the second elongated element end being bent inward approximately ninety degrees tangent to the loop, and the first elongated element end configured to overlap the second elongated element end to form a notch.

In a second exemplary embodiment of a collection apparatus to gather and hold one or more collectables, including an elongated element configured as a square, the elongated element having a first elongated element end and a second elongated element end, the first elongated element end being bent inward approximately ninety degrees tangent to the square and the second elongated element end being bent inward approximately ninety degrees tangent to the square, and the first elongated element end configured to overlap the second elongated element end to form a notch.

It is an object of the disclosure herein to provide an easy way to collect and hold wire, keys, trinkets, cable, twine, rope, wire, conduit, or the like therein V-notch lock loop collection apparatus.

It is an object of the disclosure herein to provide a notch lock loop collection apparatus and it is contemplated that other configurations other than a V are included herein, such as an U, X, and the like.

It is an object of the disclosure herein to provide a notch lock loop collection apparatus and it is contemplated that other configurations other than V end points are included herein, such as ball, loop, triangle, and the like and combinations thereof to prevent snagging on content held therein.

A feature of the present disclosure includes a loop however the loop may be configured as any shape or contour suitable to one of ordinary skill in the art to collect items or parts therein V-notch lock loop, such as circle, square, rectangle (construed same as square), triangle, arching, polygon, or other similar shapes.

A feature of the present disclosure includes utilizing a plurality of notch lock loops that may be configured to affix a linear run item(s) along the item run.

A feature of the present disclosure includes configurations such as a wire which may include any linear flexible, slightly bendable, or springable configuration, such as a wire, bar, rod, flat, channel, or the like.

A feature of the present disclosure includes attachment device which may include nail, screw, automotive or appliance plug or adapter to affix to an aperture in sheet metal or plastic, or the like.

These and other features of the notch lock loop and methods of use will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The present disclosure for a notch lock loop and methods of use will be better understood by reading the Detailed Description of the Preferred and Selected Alternate Embodiments with reference to the accompanying drawing Figures, in which like reference numerals denote similar structure and refer to like elements throughout, and in which:

FIG. 1A is a top side view of a V-notch lock loop with the first wire end being bent inward approximately ninety degrees and second wire end being bent inward approximately ninety degrees according to select embodiments of the disclosure;

FIG. 1B is a top side view of a V-notch lock loop of FIG. 1A with an attachment device affixed to one side according to select embodiments of the disclosure;

FIG. 1C is a top side view of a V-notch lock loop of FIG. 1A with a pair of attachment devices affixed to one to each side according to select embodiments of the disclosure;

FIG. 1D is a top side view of a V-notch lock loop of FIG. 1A with an attachment device affixed to an end opposite the V-notch according to select embodiments of the disclosure;

FIG. 1E is a perspective view of a V-notch lock loop of FIG. 1A with one or more collectables held therein V-notch lock loop by inserting the collectable therethrough the V-notch according to select embodiments of the disclosure;

FIG. 1F is a top side view of a V-notch lock loop of FIG. 1A with V notch first and second wire ends configurations to prevent snags on content according to select embodiments of the disclosure;

FIG. 2A is a top side view of a V-notch lock loop with the first wire end being bent inward approximately ninety degrees and second wire end being bent inward approximately ninety degrees according to select embodiments of the disclosure;

FIG. 2B is a top side view of a V-notch lock loop of FIG. 2A with an attachment device affixed to one side according to select embodiments of the disclosure;

FIG. 2C is a top side view of a V-notch lock loop of FIG. 2A with a pair of attachment devices affixed to one to each side according to select embodiments of the disclosure;

FIG. 2D is a top side view of a V-notch lock loop of FIG. 2A with an attachment device affixed to an end opposite the V-notch according to select embodiments of the disclosure;

FIG. 2E is a perspective view of a V-notch lock loop of FIG. 2A with one or more collectables held therein V-notch lock loop by inserting the collectable therethrough the V-notch according to select embodiments of the disclosure; and

FIG. 3 is a top side view of a plurality of V-notch lock loops of FIG. 1A shown affixed in line to a linear member according to select embodiments of the disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

In describing the exemplary embodiments of the present disclosure, as illustrated in the figures, specific terminology is employed for clarity. The present disclosure, however, is not intended to be limited to the specific terminology selected; it is to be understood that each specific element includes all technical equivalents that operate in a similar manner to accomplish similar functions. Embodiments of the claims may, however, be embodied in many different forms and should not be construed as limited to the embodiments set forth herein. The examples set forth herein are non-limiting examples, and are merely examples among other possible examples. It is recognized herein that the optimum dimensional relationships, to include variations in size, materials, shape, form, position, connection, function and manner of operation, assembly and use, are intended to be encompassed by the present disclosure.

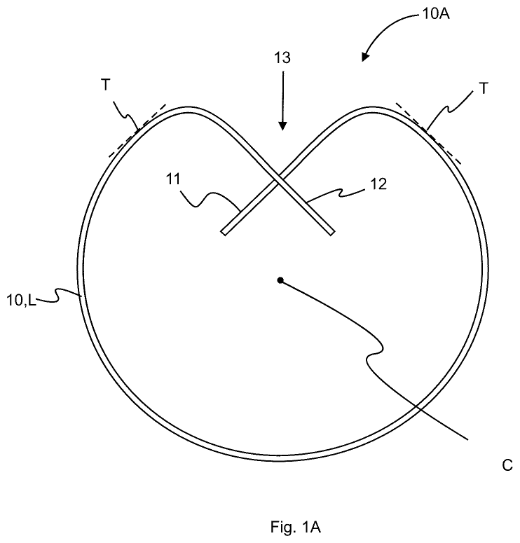

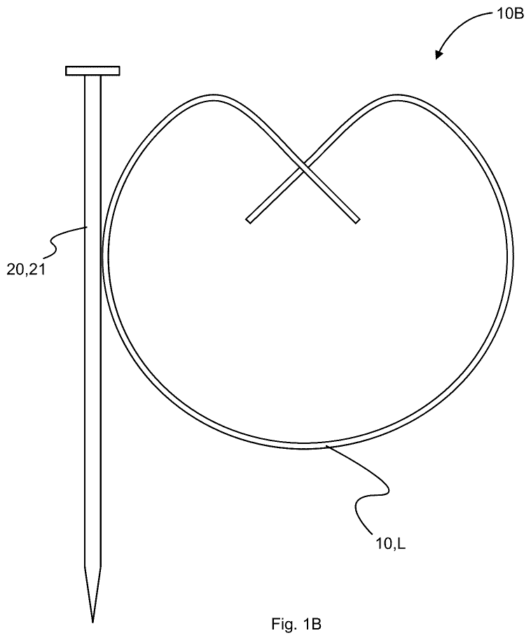

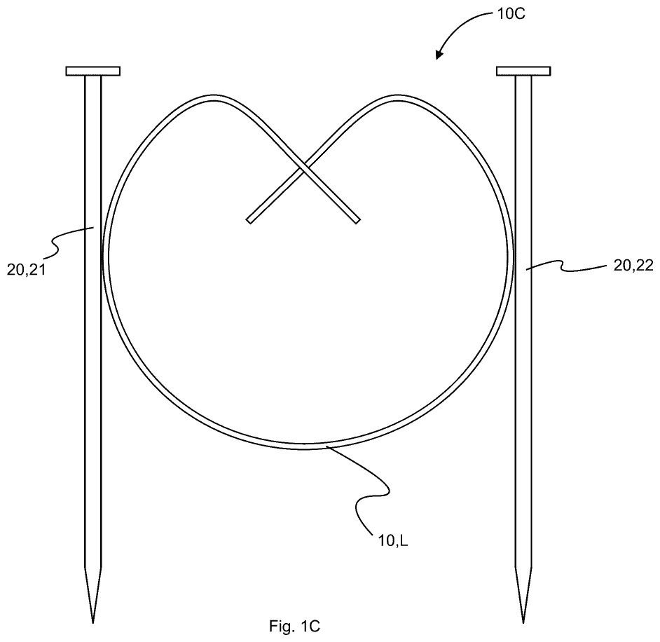

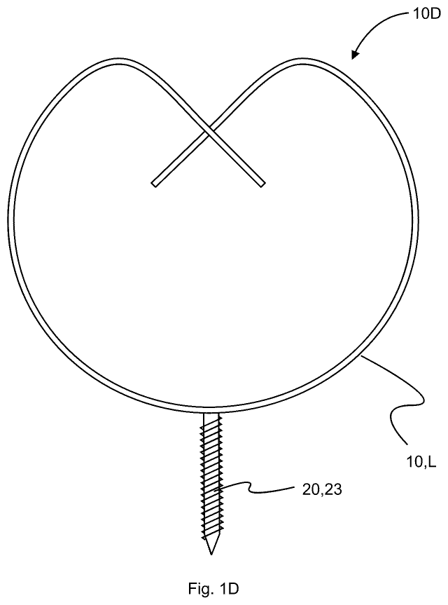

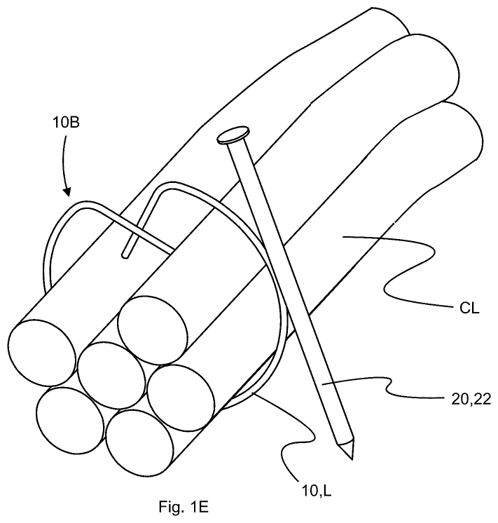

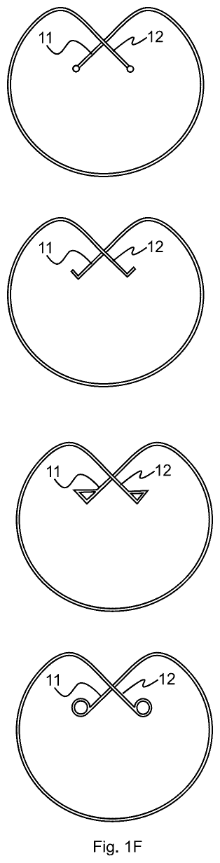

Referring now to FIGS. 1A, 1B, 1C, 1D, and 1E by way of example, and not limitation, there is illustrated an example embodiment of V-notch lock loop 10A. V-notch lock loop 10A may be formed from an elongated element, such as wire 10 and configured as loop L having first elongated element end, such as first wire end 11 and second elongated element end, such as second wire end 12. First wire end 11 may be bent inward toward the center C of the loop L approximately ninety degrees and tangent T to the loop L. Second wire end 12 may be bent inward toward the center C of the loop L approximately ninety degrees and tangent T to the loop L, wherein first wire end 11 and second wire end 12 are configured to overlap one another to form V-notch 13 therein loop L. In this embodiment loop L of wire 10 is preferably and approximately circular configuration therearound center C.

It is contemplated herein that first wire end 11 and second wire end 12 may be angled or curved further or angled or curved a second time.

It is contemplated herein that wire 10 may be constructed of metal, plastic, alloy, steel, stainless steel, aluminum, carbon fiber, or like material capable of manufacturing wire 10. Moreover, wire 10 may include any linear flexible, slightly bendable, or springable material, such as a bar, rod, flat, channel, or the like.

With respect to the disclosure herein, it is to be realized that the optimum dimensional relationships, including variations in size, materials, shape, form, configuration, position, connection features, function and manner of operation, assembly and use, are intended to be encompassed by the present disclosure.

Additional features and advantages of the disclosure will be set forth in the following description, which will be apparent from the description, or may be learned by practice of the disclosure. The foregoing general description and the following detailed description are exemplary and explanatory and are intended to further explain the disclosure.

Referring again to FIGS. 1B, 1C, and 1D, by way of example, and not limitation, there is illustrated an example embodiment of V-notch lock loop 10A with attachment device 20, 21 configured to releasably affix V-notch lock loop 10A to a surface S. Referring to FIG. 1B, by way of example, and not limitation, there is illustrated an example embodiment of V-notch lock loop 10B with attachment device 20 affixed to one side (21) of wire 10 and tangent T to the loop L. Referring to FIG. 1C, by way of example, and not limitation, there is illustrated an example embodiment of V-notch lock loop 10C with attachment devices 20, first attachment device 21, second attachment device 22 each affixed to one side (21) and another side (22) of wire 10 and tangent T to the loop L. Referring to FIG. 1D, by way of example, and not limitation, there is illustrated an example embodiment of V-notch lock loop 10D with attachment device 20, 23 affixed to bottom or opposite side (23) of wire 10, approximately opposite V-notch 13 and approximately ninety (90) degrees to the tangent T of loop L.

It is contemplated herein that attachment device 20 may include a nail, pair of nails, screw, pair of screws, automotive or appliance plug or adapter utilized to releasably affix V-notch lock loop 10, 10A to a surface S, aperture in sheet metal or plastic, or the like.

Referring again to FIG. 1E, by way of example, and not limitation, there is illustrated an example embodiment of V-notch lock loop 10B having one or more collectables CL inserted or pushed therethrough V-notch 13 and held by V-notch lock loop 10B.

It is contemplated herein that V-notch lock loop 10, 10A-E may collect and hold collectables CL, such as but not limited to wire, keys, trinkets, cable, twine, rope, wire, conduit, or the like.

Referring again to FIG. 1F, by way of example, and not limitation, there is illustrated an example embodiment of V-notch lock loop 10A having first wire end 11 and second wire end 12 configured to prevent snags on collectables CL contained therein. First wire end 11 and second wire end 12 may include ball end, angled end, triangle, loop and the like.

It is further contemplated herein that notch 13 may be configured as a V, U, or the like.

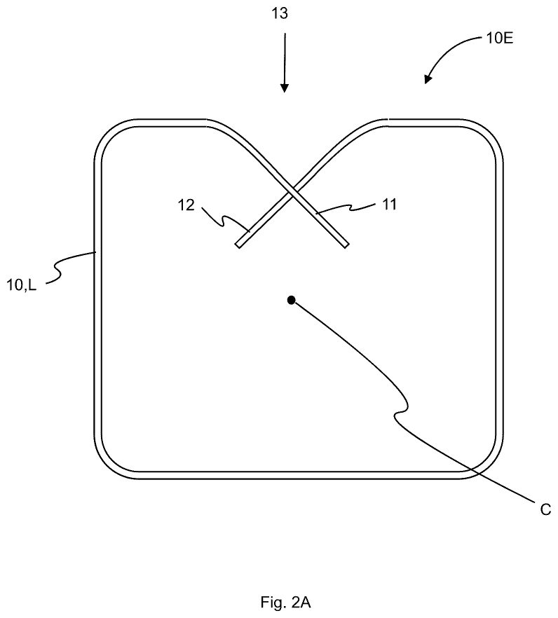

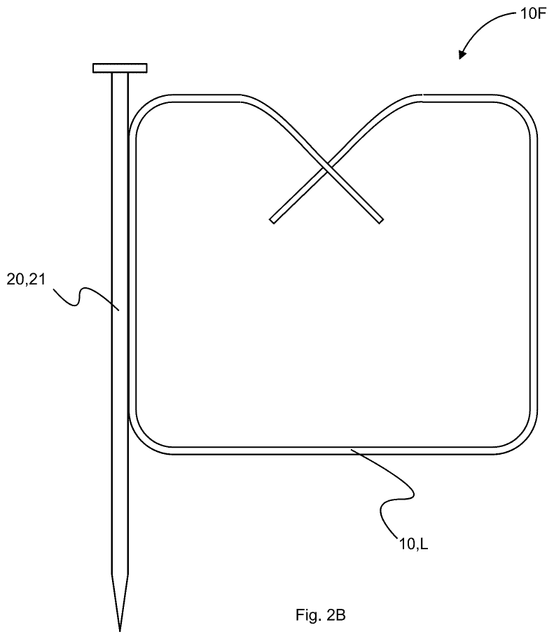

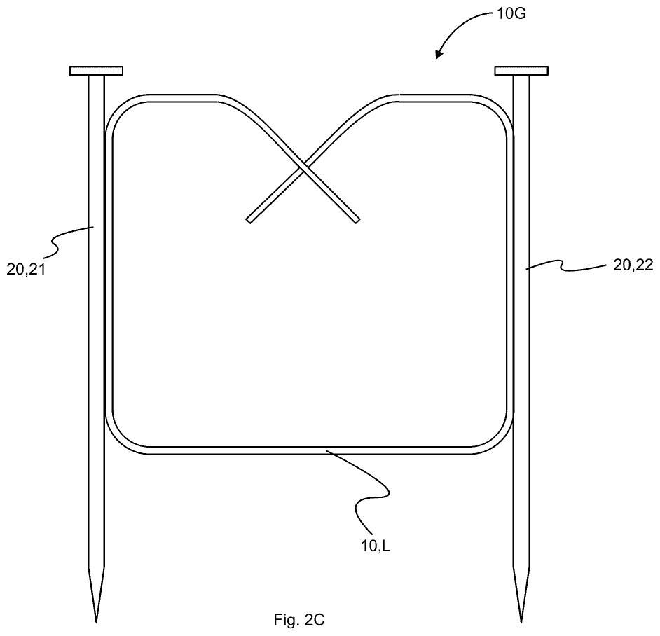

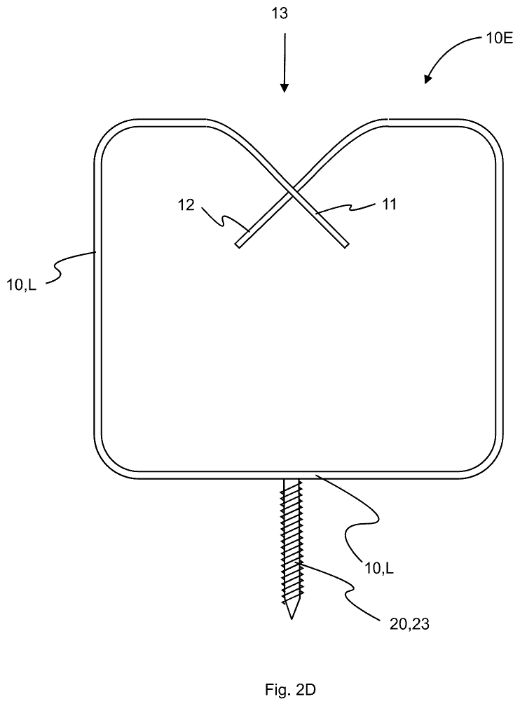

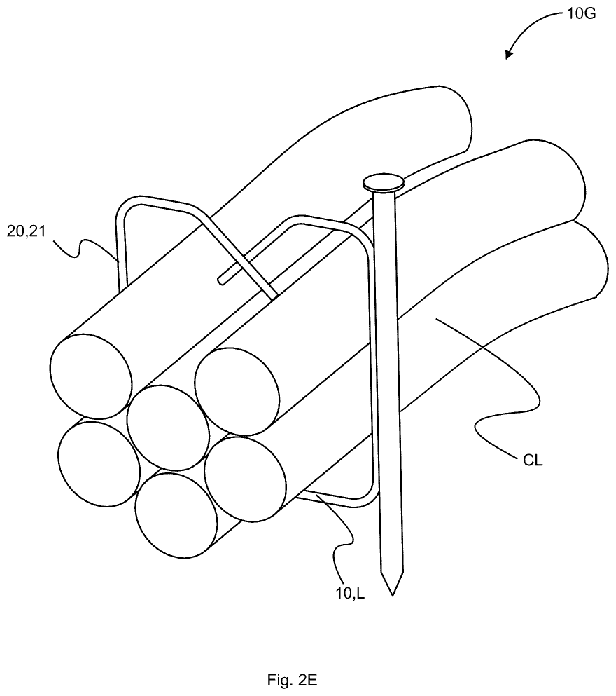

Referring now to FIGS. 2A, 2B, 2C, 2D, and 2E by way of example, and not limitation, there is illustrated an example embodiment of V-notch lock loop 10E. V-notch lock loop 10E may be formed from an elongated element, such as wire 10 and configured as loop L having first elongated element end 11 and second elongated element end 12. First elongated element end 11 may be bent inward toward the center C of the loop L approximately ninety degrees and tangent T to the loop L. Second elongated element end 12 may be bent inward toward the center C of the loop L approximately ninety degrees and tangent T to the loop L, wherein first elongated element end 11 and second elongated element end 12 are configured to overlap one another to form V-notch 13 therein loop L. In this embodiment loop L of wire 10 is preferably and approximately square configuration therearound center C. It is contemplated herein that loop L of wire 10 may be configured in other configurations, such as circle, square, rectangle (construed same as square), triangle, aching, polygon, or other similar shapes.

It is contemplated herein that wire 10 may be constructed of metal, plastic, alloy, steel, stainless steel, aluminum, carbon fiber, or like material capable of manufacturing wire 10. Moreover, wire 10 may include any linear flexible, slightly bendable, or springable material, such as a bar, rod, flat, channel, or the like.

With respect to the disclosure herein, it is to be realized that the optimum dimensional relationships, including variations in size, materials, shape, form, configuration, position, connection features, function and manner of operation, assembly and use, are intended to be encompassed by the present disclosure.

Referring again to FIGS. 2B, 2C, and 2D, by way of example, and not limitation, there is illustrated an example embodiment of V-notch lock loop 10E with attachment device 20, 21 configured to releasably affix V-notch lock loop 10E to a surface S. Referring to FIG. 2B, by way of example, and not limitation, there is illustrated an example embodiment of V-notch lock loop 10F with attachment device 20 affixed to one side (21) of wire 10 and tangent T to the loop L. Referring to FIG. 2C, by way of example, and not limitation, there is illustrated an example embodiment of V-notch lock loop 10G with attachment devices 20, 21, 22 each affixed to one side (21) and another side (22) of wire 10 and tangent T to the loop L. Referring to FIG. 2D, by way of example, and not limitation, there is illustrated an example embodiment of V-notch lock loop 10H with attachment device 20, 23 affixed to a bottom side of wire 10, approximately opposite V-notch 13 and approximately ninety (90) degrees to the tangent T of loop L.

It is contemplated herein that attachment device 20 may include a nail, pair of nails, screw, pair of screws, automotive or appliance plug or adapter utilized to releasably affix V-notch lock loop 10A to a surface S, aperture in sheet metal or plastic, or the like.

Referring to FIG. 2E, by way of example, and not limitation, there is illustrated an example embodiment of V-notch lock loop 10F having one or more collectables CL inserted or pushed therethrough V-notch 13 and held by V-notch lock loop 10F.

It is contemplated herein that V-notch lock loop 10E-H may collect and hold collectables CL, such as but not limited to wire, keys, trinkets, cable, twine, rope, wire, conduit, or the like.

It is contemplated herein that V-notch lock loop 10 may be configured or shaped as circle, square, rectangle (construed same as square), triangle, arching, polygon, or other similar shapes.

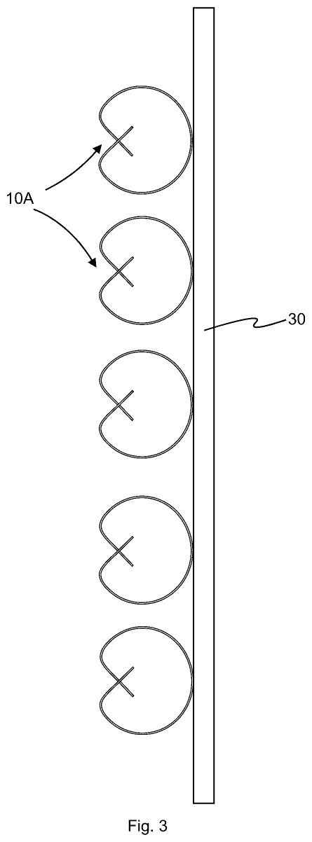

Referring to FIG. 3, by way of example, and not limitation, there is illustrated an example embodiment of a plurality of V-notch lock loop 10A affixed in line to linear member 30. Plurality of elongated elements configured as a loop, such as V-notch lock loop 10A affixed in line to linear member 30 may be utilized to fasten or hold sets of one or more collectables CL therein. Moreover, linear member 30 may be affixed or removeably affixed to a surface or support member (not shown).

Moreover, V-notch lock loop 10A material selection may include properties of flexibility to provide hingeability (hingeable), flexibility, and bendability, to enable insertion of one or more collectables CL therethrough notch 13 of lock loops herein.

Concerning the description herein, it is to be realized that the optimum dimensional relationships, including variations in size, materials, shape, form, configuration, position, connection, function and manner of operation, assembly and use, are intended to be encompassed by the present disclosure.

It is further understood herein that the parts and elements of this disclosure may be located or positioned elsewhere based on one of ordinary skill in the art without deviating from the present disclosure.

With respect to the above description, it is to be realized that the optimum dimensional relationships, including variations in size, materials, shape, form, position, movement mechanisms, function and manner of operation, assembly and use, are intended to be encompassed by the present disclosure.

The foregoing description and drawings comprise illustrative embodiments. Regarding the described exemplary embodiments, it should be noted by those skilled in the art that the disclosures within are exemplary only, and that various other alternatives, adaptations, and modifications may be made within the scope of the present disclosure. Merely listing or numbering the steps of a method in a particular order does not constitute any limitation on the order of the steps of that method. Many modifications and other embodiments will come to mind for one skilled in the art this disclosure pertains to, having the benefit of the teachings presented in the foregoing descriptions and the associated drawings. Although specific terms may be employed herein, they are used in a generic and descriptive sense only and not for purposes of limitation. Moreover, the present disclosure has been described in detail; it should be understood that various changes, substitutions and alterations can be made thereto without departing from the spirit and scope of the disclosure as defined by the appended claims. Accordingly, the present disclosure is not limited to the specific embodiments illustrated herein but is limited only by the following claims.

1. A collection apparatus to gather and hold one or more collectables, said apparatus comprising:
an elongated element configured as a loop, said elongated element having a first elongated element end and a second elongated element end, said first elongated element end being bent inward approximately ninety degrees tangent to said loop and said second elongated element end being bent inward approximately ninety degrees tangent to said loop, and said first elongated element end configured to overlap said second elongated element end to form a notch.

2. The apparatus of claim 1, wherein said elongated element configured as a loop further comprising an attachment device affixed to one side of said elongated element.

3. The apparatus of claim 1, wherein said elongated element configured as a loop further comprising a first attachment device affixed to one side of said elongated element and a second attachment device affixed to another side of said elongated element.

4. The apparatus of claim 1, wherein said elongated element configured as a loop further comprising an attachment device affixed to a bottom side of said elongated element opposite said notch.

5. The apparatus of claim 1, wherein said first elongated element end and said second elongated element end further comprising an end selected from the group consisting of a ball end, an angled end, a triangle, a loop and combinations thereof.

6. The apparatus of claim 1, wherein said first elongated element end is configured to overlap said second elongated element end to form said notch further comprising said notch selected from the group consisting of a V shape, a U shape and combinations thereof.

7. The apparatus of claim 1, wherein a plurality of elongated elements configured as said loop are affixed to a linear member to hold therein sets of the one or more collectables.

8. The apparatus of claim 1, wherein said loop further comprising a shape selected from the group consisting of a circle, a square, a rectangle, a triangle, an arch, a polygon and combinations thereof.

9. A collection apparatus to gather and hold one or more collectables, said apparatus comprising:
an elongated element configured as a square, said elongated element having a first elongated element end and a second elongated element end, said first elongated element end being bent inward approximately ninety degrees tangent to said square and said second elongated element end being bent inward approximately ninety degrees tangent to said square, and said first elongated element end configured to overlap said second elongated element end to form a notch.

10. The apparatus of claim 9, wherein said elongated element configured as said square further comprising an attachment device affixed to one side of said elongated element.

11. The apparatus of claim 9, wherein said elongated element configured as said square further comprising a first attachment device affixed to one side of said elongated element and a second attachment device affixed to another side of said elongated element.

12. The apparatus of claim 9, wherein said elongated element configured as said square further comprising an attachment device affixed to a bottom side of said elongated element opposite said notch.

13. The apparatus of claim 9, wherein said first elongated element end and said second elongated element end further comprising an end selected from the group consisting of a ball end, an angled end, a triangle, a loop and combinations thereof.

14. The apparatus of claim 9, wherein said first elongated element end is configured to overlap said second elongated element end to form said notch further comprising said notch selected from the group consisting of a V shape, a U shape and combinations thereof.

15. The apparatus of claim 9, wherein a plurality of elongated elements configured as said square are affixed to a linear member to hold therein sets of the one or more collectables.
